(19) United States
(12) Patent Application Publication
(10) Pub. No.: US 2025/0135829 A1
(43) Pub. Date: May 1, 2025

(54) APPARATUS AND METHOD FOR CONTROLLING ACTUATOR USING VIBRATION ANALYSIS TECHNIQUE

(71) Applicant: HL MANDO CORPORATION, Gyeonggi-do (KR)

(72) Inventor: Woojin JHONG, Gyeonggi-do (KR)

(21) Appl. No.: 18/616,174

(22) Filed: Mar. 26, 2024

(30) Foreign Application Priority Data
Oct. 25, 2023 (KR) 10-2023-0143754

(51) Int. Cl. B60G 17/0165; B60G 17/02; B60G 17/04

(52) U.S. Cl. CPC B60G 17/0165; B60G 17/021; B60G 17/04; B60G 2202/12; B60G 2202/152; B60G 2400/82

(57) ABSTRACT

A method of controlling an actuator may include calculating an input load received by or applied to a suspension system of a vehicle, including at least one of a spring unit, a damper unit, and a vibration isolation unit or isolator; decomposing the calculated input load received by the suspension system for each of frequencies through a frequency decoder, generating control signals for each of the frequencies to control at least one of the spring unit, the damper unit, and the vibration isolation unit or isolator included in the suspension system; and applying the control signals generated for each of the frequencies to at least one of the spring unit, the damper unit, and the vibration isolation unit or isolator included in the suspension system in order to control at least one of the spring unit, the damper unit, and the vibration isolation unit or isolator.

### CROSS-REFERENCE TO RELATED APPLICATION

This application claims priority under 35 U.S.C. § 119 to Korean Patent Application No. 10-2023-0143754, filed on Oct. 25, 2023, in the Korean Intellectual Property Office (KIPO), the disclosure of which is incorporated by reference herein in its entirety.

### TECHNICAL FIELD

The present disclosure generally relates to an apparatus and a method for controlling an actuator to improve ride comfort and steering stability using a vibration analysis technique. Specifically, some embodiments of the present disclosure may provide an apparatus and a method for controlling an actuator to provide optimal ride comfort and steering stability by analyzing an input load of a chassis using vibration analysis techniques and controlling actuators.

### BACKGROUND

A vehicle's ride comfort and steering stability are important factors of determining the driving quality that a driver and passengers feel when driving a vehicle. They may be influenced by irregularities on the road, the speed and the operation of the vehicle, and a range of factors occurring in the external environment. To improve such ride comfort and steering stability, various components of a suspension system have been researched and developed.

Conventionally, the main components of suspension, such as springs, dampers (or shock absorbers), and anti-vibration rubber, have been designed to be individually optimized. That is, each component has been tuned to its own target performance. For example, springs are primarily designed to support the weight of a vehicle, dampers are designed to control vibrations resulting from road irregularities, and anti-vibration rubber is designed to reduce the vibration and noise. There are various approaches to improve ride comfort and steering stability of vehicles, for example, Korean Patent Nos. 10-2395275 and 10-0593416.

### Related Patent Documents

(1) Korean Patent No. 10-2395275 (issued on May 2, 2022)
(2) Korean Patent No. 10-0593416 (issued on Jun. 19, 2006)

### SUMMARY

The present disclosure may provide optimal ride comfort and steering stability by analyzing an input load delivered to a suspension system through vibration analysis techniques and controlling individual actuators.

However, the technical problems to be solved by the present disclosure are not limited to those described above, and there may be other technical problems.

A method of controlling an actuator to improve riding comfort and steering stability according to an embodiment of the present disclosure may involve calculating an input load to be received by a suspension system of a vehicle, including at least one of a spring unit, a damper unit, and a vibration isolation unit; decomposing the calculated input load received by the suspension system for each frequency through a frequency decoder; generating control signals for each of the frequencies to control at least one of the spring unit, the damper unit, and the vibration isolation unit included in the suspension system; and applying the control signals generated for each of the frequencies to at least one of the spring unit, the damper unit, and the vibration isolation unit included in the suspension system in order to control at least one of the spring unit, the damper unit, and the vibration isolation unit.

According to an embodiment of the present disclosure, the calculating of the input load may involve calculating the input load by sensing the movement of at least one of the vehicle body, the spring unit, and the damper unit through a sensor when the vehicle passes on the road surface having its profile.

According to an embodiment of the present disclosure, the calculating of the input load may involve calculating the input load by receiving the profile of the road surface from a sensor for inputting information about the front or a high-definition map (HD map).

According to an embodiment of the present disclosure, examples of the sensor for inputting information about the front may include a preview camera, a light detection and ranging (LiDAR), a high-definition camera, a RADAR, an inertial measurement unit (IMU), a global positioning system (GPS), a time-of-flight (ToF) camera, a thermal camera, and a stereo camera.

According to an embodiment of the present disclosure, the frequencies may include at least a first frequency in a first frequency band, a second frequency in a second frequency band, and a third frequency in a third frequency band.

According to an embodiment of the present disclosure, the spring unit may include a coil spring or an air spring; in the coil spring, only the stroke may be controlled by a stroke function in the first frequency; the air spring may be controlled by the pump capacity and the compressibility of a fluid in the first frequency; the damper unit may be controlled according to the characteristics of a valve as a speed function in the second frequency; and the vibration isolation unit may be controlled by the properties of variable materials in the third frequency.

According to an embodiment of the present disclosure, the first frequency may be in a range of 0 Hz to 5 Hz, the second frequency may be in a range of 3 Hz to 25 Hz, and the third frequency may be in a range of 20 Hz to 250 Hz.

According to an embodiment of the present disclosure, the following steps may be included: calculating an input load to be received by an active suspension of a vehicle while driving; decomposing the calculated input load received by the active suspension for each frequency through a frequency decoder; generating control signals for each of the frequencies to control the active system; and applying the control signals generated for each of the frequencies to the active suspension in order to control the active suspension.

A method of controlling an actuator to improve riding comfort and steering stability according to another embodiment of the present disclosure may include a) setting a target ride comfort expressed in indices; b) calculating an input load received by a vehicle's suspension system including at least one of a spring unit, a damper unit, and a vibration isolation unit; c) decomposing the calculated input load received by the suspension system for each frequency through a frequency decoder; d) generating control signals for each of the frequencies to control at least one of the spring unit, the damper unit, and the vibration isolation unit included in the suspension system; e) applying the control signals generated for each of the frequencies to at least one of the spring unit, the damper unit, and the vibration isolation unit included in the suspension system in order to control at least one of the spring unit, the damper unit, and the vibration isolation unit; and f) determining whether the target ride quality is satisfied and repeating the steps b) to e) until the target ride quality is reached.

According to an embodiment of the present disclosure, the calculating of the input load may involve calculating the profile of the road surface by sensing the movement of at least one of the vehicle body, the spring unit, and the damper unit through a sensor when the vehicle passes on the road surface.

According to an embodiment of the present disclosure, the calculating of the input load may involve calculating the input load by receiving the profile of the road surface from a sensor for inputting information about the front or a high-definition map (HD map).

According to an embodiment of the present disclosure, the frequencies may include at least a first frequency in a first frequency band, a second frequency in a second frequency band, and a third frequency in a third frequency band.

According to an embodiment of the present disclosure, the spring unit may include a coil spring or an air spring; in the coil spring, only the stroke may be controlled by a stroke function in the first frequency; the air spring may be controlled by the pump capacity and the compressibility of a fluid in the first frequency; the damper unit may be controlled according to the characteristics of a valve as a speed function in the second frequency; and the vibration isolation unit may be controlled by the properties of variable materials in the third frequency.

According to an embodiment of the present disclosure, the first frequency may be in a range of 0 Hz to 5 Hz, the second frequency may be in a range of 3 Hz to 25 Hz, and the third frequency may be in a range of 20 Hz to 250 Hz.

According to an embodiment of the present disclosure, the index may be determined based on a combination of one or more of the index items of Primary Ride, Impact Harshness/Hardness, Choppy Ride, Shake Vibration, Suspension Noise, Steering Feel, Yaw Response and Damping, Steer Linearity, and Roll Stability.

An apparatus for controlling an actuator to improve riding comfort and steering stability according to another embodiment of the present disclosure may include a suspension system including at least one of a spring unit, a damper unit, and a vibration isolation unit; an input load calculation unit that calculates an input load received by the suspension system; a frequency decoder that decomposes the input load measured by sensors for each frequency by the fast Fourier transform (FFT); a microcontroller unit (MCU) that generates a control value for an actuator that controls at least one of the spring unit, the damper unit, and the vibration isolation unit included in the suspension system, based on a target ride comfort expressed in indices; and an electronic control unit (ECU) that receives the control value for the actuator from the microcontroller unit in order to generate a signal to control at least one of the spring unit, the damper unit, and the vibration isolation unit.

According to an embodiment of the present disclosure, the MCU may calculate the difference between a resulting value of controlling at least one of the spring unit, the damper unit, and the vibration isolation unit based on the input target ride comfort and a state value indicating the current state of a vehicle and may update the control value for the actuator to satisfy a predetermined target value.

According to an embodiment of the present disclosure, the input load calculation unit may calculate the input load by sensing the movement of at least one of the vehicle body, the spring unit, and the damper unit through a sensor when the vehicle passes on the profile of the road surface.

According to an embodiment of the present disclosure, the input load calculation unit may calculate the input load by receiving the profile of the road surface from a sensor for inputting information about the front or a high-definition map (HD map).

According to an embodiment of the present disclosure, the frequencies may include at least a first frequency in a first frequency band, a second frequency in a second frequency band, and a third frequency in a third frequency band.

According to an embodiment of the present disclosure, the spring unit may include a coil spring or an air spring; in the coil spring, only the stroke may be controlled by a stroke function in the first frequency; the air spring may be controlled by the pump capacity and the compressibility of a fluid in the first frequency; the damper unit may be controlled according to the characteristics of a valve as a speed function in the second frequency; and the vibration isolation unit may be controlled by the properties of variable materials in the third frequency.

According to an embodiment of the present disclosure, the first frequency may be in a range of 0 Hz to 5 Hz, the second frequency may be in a range of 3 Hz to 25 Hz, and the third frequency may be in a range of 20 Hz to 250 Hz.

According to the present disclosure, it may be possible to provide optimal ride comfort and steering stability by analyzing an input load delivered to a suspension system through vibration analysis techniques and controlling individual actuators for each frequency.

### BRIEF DESCRIPTION OF THE DRAWINGS

FIG. 1 is a block diagram for illustrating an apparatus for controlling an actuator to improve riding comfort and steering stability according to an embodiment of the present disclosure.

FIG. 2 is a spider web diagram showing riding comfort expressed in multiple indices according to an embodiment of the present disclosure.

FIG. 3 is a schematic view for schematically showing the profile of a road surface and a suspension system according to an embodiment of the present disclosure.

FIG. 4 is a graph for showing a frequency spectrum according to an embodiment of the present disclosure.

FIG. 5 is a flowchart for showing a method of controlling an actuator to improve riding comfort and steering stability of a vehicle according to an embodiment of the present disclosure.

FIG. 6 is a flowchart for showing a method of controlling an actuator to improve riding comfort and steering stability of a vehicle according to another embodiment of the present disclosure.

### DETAILED DESCRIPTION

Hereinafter, with reference to the attached drawings, the embodiments of the present disclosure will be described in detail so that a person having ordinary skill in the art can easily carry out the embodiments of the present disclosure. Because various changes can be made to the present disclosure and various embodiments thereof are possible, specific embodiments will be illustrated in the drawings and described in detail in the detailed description. However, these are not intended to limit the present disclosure to specific embodiments, and the present disclosure should be understood to include all changes, equivalents, or substitutes within the scope of the technology of the present disclosure.

In order to clearly describe the present disclosure, parts unrelated to the description have been omitted from the drawings, and similar parts have been assigned similar drawing reference numerals throughout the specification. In addition, while describing the features with reference to the drawings, features having the same name may be assigned different reference numerals in each drawing. Drawing reference numerals are merely written for convenience of description, and the concept, the characteristics, the function, or the effect of each feature is not limited by its reference numeral.

While describing the drawings, similar components are given similar reference numerals. Expressions such as first and second may be used to describe various components, but the components should not be limited by the expressions. Such expressions are used only for the purpose of distinguishing one component from another. For example, a first component may be referred to as a second component, and similarly, the second component may be referred to as the first component within the scope of the present disclosure. By the expression “and/or,” a combination of a plurality of related items or any one of the plurality of related items is included.

Unless otherwise defined, all terms used herein, including technical or scientific terms, have meanings commonly understood by a person having ordinary skill in the art to which the present disclosure pertains.

Terms defined in common dictionaries should be considered to have the meanings they have in the context of a relevant technology, and should not be construed in an idealized or overly formal sense unless explicitly defined in the present disclosure.

Throughout the present disclosure, when a part is said to be “connected” to another part, the part may be “directly connected” or “indirectly connected” to the other part or may be “electrically connected” or “operably connected” thereto with another element in between. In addition, when a part is said to “include” a certain component, this means that it may further include other components, rather than excluding other components, unless specifically stated to the contrary, and should not be understood to preclude the presence or the addition of one or more other features, numbers, steps, operations, components, parts, or combinations thereof.

Hereinafter, with reference to the attached drawings, an apparatus and a method for controlling an actuator to improve riding comfort and steering stability using a vibration analysis technique according to the present disclosure will be described in detail.

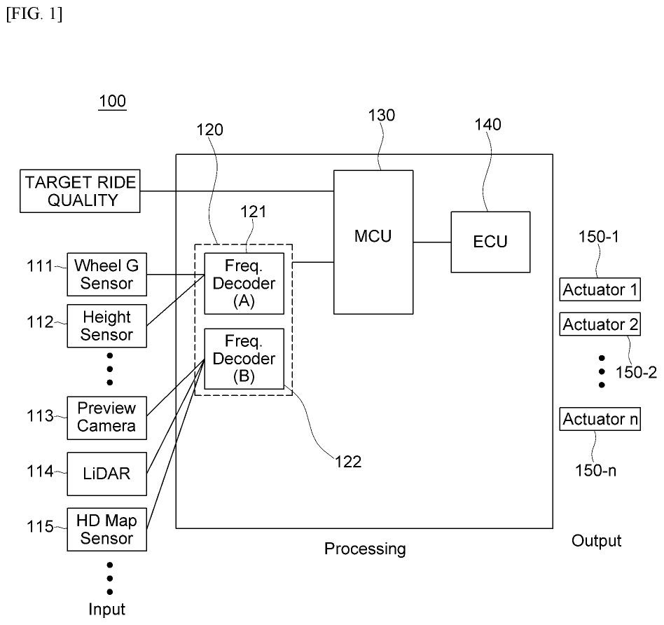

FIG. 1 is a block diagram for illustrating an apparatus for controlling an actuator to improve riding comfort and steering stability according to an embodiment of the present disclosure.

Referring to FIG. 1, an apparatus 100 for controlling an actuator to improve riding comfort and steering stability may include a wheel G sensor 111, a height sensor 112, a preview camera 113, a light detection and ranging (LiDAR) 114, an high-definition (HD) map 115, a frequency decoder 120, 121, and 122, a microcontroller unit (MCU) 130, an electronic control unit (ECU) 140, and actuators 150-1, 150-2, . . . , 150-n (n is a natural number equal to or greater than one).

The wheel G sensor 111 may be a sensor configured to measure G-force in a wheel or a tire. The wheel G sensor 111 may provide information about traction, wheel slip, or other indicators of performance, related to how wheels are in contact with the road.

The height sensor 112 may be mainly used in conjunction with an electronically controlled suspension system and may be configured to sense changes in a relative height between the height of a vehicle's body and wheels. The height sensor 112 may be implemented as various types of sensors, such as a potentiometer, a hall effect sensor, or a piezoelectric sensor, but is not limited thereto.

The wheel G sensor 111 and the height sensor 112 may be used to measure the profile of the road surface when the vehicle is driving and provide it to a first frequency decoder 121. The information or data obtained or sensed by the wheel G sensor 111 and the height sensor 112 according to an embodiment of the present disclosure and provided to the first frequency decoder 121 may be information about the profile of the road surface indicating the current state of the road surface. Here, the profile of the road surface may refer to sensed results of measuring irregularities, defects, and changes in height on the road surface, which are factors that affect ride comfort when driving a vehicle. Such a profile may be used as an important indicator in evaluating the wear, the damage and the lifespan of the road, etc. and, in particular, may be used as important references when designing a vehicle suspension or repairing roads.

The preview camera 113 may have a sensing device or sensor configured to monitor environment in front of the vehicle in real time to obtain information about conditions of the road and its surface, the preview camera 113 may sense even minute characteristics such as irregularities, obstacles, potholes, and sudden changes in height on the road through its high-resolution and high-speed processing capabilities.

The LiDAR 114 may be a sensor configured to measure distances and shapes in the surrounding environment of the vehicle by transmitting laser pulses at high speed and sensing their reflection. For example, the data output by the LiDAR may be expressed as a 3D point cloud of the surrounding environment, through which it is possible to determine the shape, the size, and the location of objects, as well as the height and the texture of the road surface.

The preview camera 113 and the LiDAR 114 are examples of sensors for inputting or sensing information about environment in front of the vehicle. However, the present disclosure is not limited thereto and any sensor capable of sensing the environment in front of the vehicle such as a high-definition camera, a RADAR, an inertial measurement unit (IMU), a global positioning system (GPS), a ToF camera, a thermal camera, and a stereo camera can be used if appropriate.

The HD map 115 may be a high-definition digital map that provides more detailed and accurate information than a typical navigation map. However, the typical navigation map also can be used in some embodiments of the present disclosure. The HD map 115 may be mainly used for autonomous vehicles and allow the vehicles to accurately recognize the surrounding environment and drive safely. The HD map 115 may be produced based on data collected by various sensors, such as preview cameras, LiDARs, and RADARs. The HD map 115 may contain detailed information about road slope, lane location, traffic signals, road signs, intersection structure, etc., and information on the map may be updated in real time by, for instance, but not limited to, vehicle-to-vehicle communication (V2V) and vehicle-to-infrastructure communication (V2I).

Information about the profile of the road surface obtained by the preview camera 113, the LiDAR 114, the HD map 115, etc. may be provided to a second frequency decoder 122, and may include information about the future of the input load from a time perspective.

The frequency decoder 120 may include the first frequency decoder 121 configured to process data input by or received from the wheel G sensor 111 and the height sensor 112, and the second frequency decoder 122 configured to process data input by or received from the preview camera 113, the LiDAR 114, and the HD map 115. The data input by or received from the first frequency decoder 121 may include information on a current input load, and the data input by or received from the second frequency decoder 122 may include information about the state of future driving, e.g., the profile of the road surface in front of a vehicle.

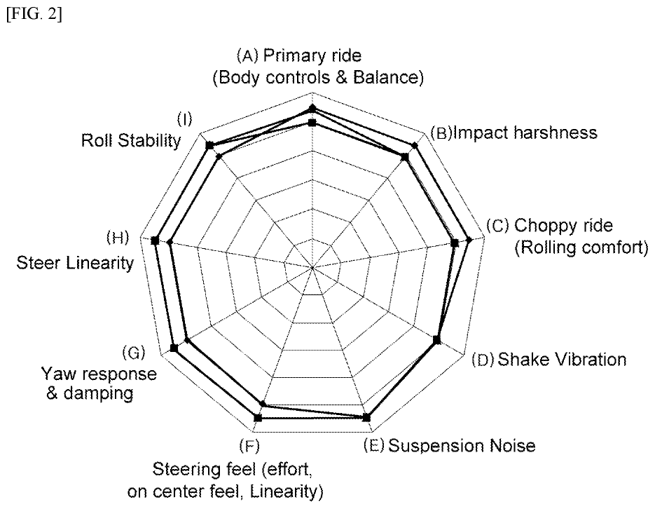

Data input by or received from the wheel G sensor 111 and the height sensor 112 may be measured in real time while a vehicle is driving and expressed as the input load received by a suspension system. For example, as shown in FIG. 2, when a vehicle is driving on the road surface having its profile, the movement of “B” (e.g., a spring) may be sensed and divided by time to obtain speed, and may be sensed and differentiated with time to obtain desired physical quantities such as acceleration. Here, regardless of whether the load of “A” (e.g., a car body), “B,” or “C” (e.g., a damper) is measured, it may be possible to calculate the input load based on the correlation.

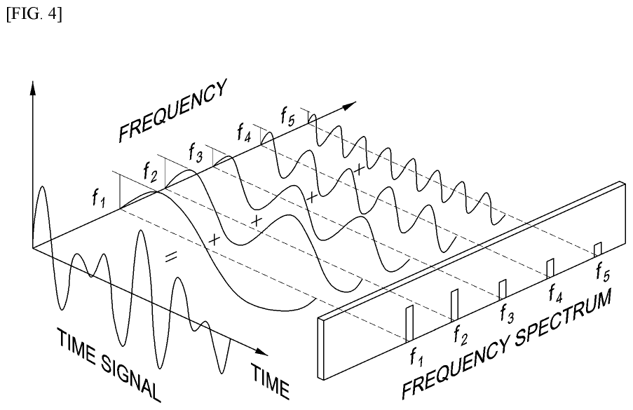

The calculated input load may be data in time domain, and the input load signal may be decomposed or transformed into frequency components based on the fast Fourier transform (FFT) by the frequency decoder 120. As described above, the frequency decoder 120 may include the first frequency decoder 121 and the second frequency decoder 122. The first frequency decoder 121 may process or express data input by the wheel G sensor 111 and the height sensor 112 as frequency components, and the second frequency decoder 122 may process or express data input by the preview camera 113, the LiDAR 114, and the HD map 115 as frequency components through the fast Fourier transform. When an input load is expressed as a frequency component, it may be expressed as a combination of multiple frequency components. For example, as shown in FIG. 4, the input load may be expressed as f1, f2, f3, f4, and f5, and, depending on each frequency component, that is, f1, f2, f3, f4, and f5, it may be determined which actuator among a plurality of actuators included in a suspension system needs to be controlled. The process of controlling an actuator of each frequency will be described below.

The MCU 130 may be an electronic device configured to control and manage various features of a vehicle. The MCU 130 may typically include, for example, but not limited to, one or more of a built-in memory, an input/output port, a timer, an interrupt, and an integrated circuit including various communication features. The MCU 130 may process various data input by sensors (e.g., a speed sensor, a temperature sensor, a fuel level sensor, etc.). In general, the MCU 130 may control the functions of output devices, such as an engine control, a brake system, a lighting, and an air conditioning, and may serve as a communication network between various devices or components in a vehicle, based on or using an internal communication network such as a controller area network (CAN) or a local interconnect network (LIN). In addition, the MCU 130 may monitor the status and the performance of a vehicle and may be configured to alert the driver of the vehicle when a problem occurs. Furthermore, the MCU 130 may be configured to update and manage a software and to manage or control a vehicle's battery and fuel. According to an embodiment of the present disclosure, the MCU 130 may process data transmitted from the frequency decoder 120 and transmit the processed data to the ECU 140.

In particular, the MCU 130 may compare the resulting value of controlling an actuator based on an input target ride comfort with the resulting value of measurement by the frequency decoder 120, and may generate control values for each actuator to satisfy a predetermined target value. For instance, the MCU 130 may control actuators included in a suspension system based on an input target ride comfort and convert the resulting value into an “objective function.” The objective function is a function to achieve a specific goal, and the difference or ratio between a target ride comfort and an actual ride comfort may be obtained according to the objective function. The MCU 130 may calculate the difference between an objective function (e.g. a desired result or state) and an actual movement of an actuator, and may generate a control value for a new actuator to minimize or eliminate the difference between the objective function and the actual movement of the actuator.

For example, the ECU 140 may be a microcomputer that controls a vehicle's electronic system, and may manage and optimize the operation of an engine, the control of a transmission, a braking system, a stability system, a lighting, an air conditioning, communication, and the interaction between various sensors and actuators. The ECU 140 may include software and hardware necessary to control at least one of several functions of a vehicle. In FIG. 1, the ECU 140 may receive one or more control values for each actuator from the MCU 130 and transmit a control signal for controlling an actuator to the actuator. According to certain embodiments of the present disclosure, the MCU 130 and the ECU 140 are shown as separate features as shown in FIG. 1, but the MCU 130 and the ECU 140 may be implemented as one integrated circuit or chip or in various forms according to design changes or necessities by a person having ordinary skill in the art.

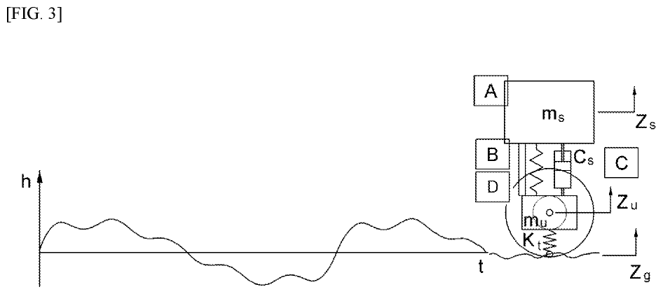

The actuators 150-1, 150-2, . . . , 150-n are included in the suspension system. The suspension system may include one or more of a spring unit, a damper unit, a vibration isolation unit, etc., as shown in FIG. 3, which will be described below, but is not limited thereto. For instance, the spring unit may include a coil spring or an air spring to be used in the suspension system, and the spring unit may be designed to adjust the tension and elasticity of the coil spring or air spring by adjusting an actuator. For example, the stroke of a coil spring may be controlled by a stroke function, and an air spring may be controlled by the pump capacity and the compressibility of a fluid.

The damper unit included in the suspension system may dynamically control the reaction force of a damper. The suspension system, which includes the damper unit, may adjust a damping pressure or a spring tension by controlling a valve based on the condition of the irregular road surface so as to control ride comfort. In addition to the spring unit and the damper unit, various devices may further be included. For example, a vibration isolation unit or isolator configured to absorb and disperse vibration and shock may be further included. Vibration isolation units or isolators can be divided or categorized into passive vibration isolation units or isolators and active vibration isolation units or isolators. The passive vibration isolation unit or isolator may be a device or isolator configured to absorb vibration and shock using elastic materials such as rubber or polyurethane. The active vibration isolation unit or isolator may operate in association or combination with an actuator to perform the operation of actively isolating vibration based on control signals corresponding to various types of vibration. Here, the active vibration isolation unit or isolator may be controlled by the properties of variable materials.

FIG. 2 is a spider web diagram showing riding comfort expressed in multiple indices according to an embodiment of the present disclosure.

Ride quality may be a term that encompasses the comfort, the stability, the responsiveness, etc. felt in a driving vehicle, and may also refer to the experience that drivers and passengers feel under various operating conditions of the vehicle. Ride comfort may be affected by several factors such as the performance of a vehicle's suspension, interior noise, vibration, wind noise, and seat comfort. Because the ride comfort is a highly subjective experience, it may feel different depending on individual experience or expectations. However, in the process of designing and tuning a vehicle, it is necessary to objectively evaluate and standardize the ride comfort. For example, the riding comfort can be expressed with several indices or be indicated with several factors using a spider web as shown in FIG. 2.

Referring to FIG. 2, an index or indicator (A) corresponds to primary ride, and is an index item indicating the level of the overall stability and the comfort felt in a vehicle, and is an indicator of the vehicle's steering ability and harmony. A well-coordinated vehicle responds predictably even in sudden movements, giving a driver and passengers a sense of balance within the vehicle.

An index or indicator (B) corresponds to impact harshness/hardness, and is an index item indicating the level of impact harshness and hardness, and indicates how strong an impact is delivered or applied to the suspension system when the vehicle is driving or going over irregular parts on the road, such as potholes or speed bumps. A well-designed suspension system can effectively absorb those impacts and provide a comfortable driving experience to a driver and passengers.

An index or indicator (C) corresponds to choppy ride, and is an index item indicating the degree of reaction of a vehicle to small road irregularities, and indicates the level of minor vibration or brief tilting from side to side. When the vehicle reacts thereto too harshly, a driver and passengers may feel uncomfortable while driving.

An index or indicator (D) corresponds to shake vibration, which is an index item indicating the degree of shake of a vehicle and/or the degree of misalignment of the vehicle in the direction of travel. The shaking and vibration that occur while the vehicle is driving on the road are delivered to the interior of the vehicle.

An index or indicator (E) corresponds to suspension noise, and is an index item indicating the level of noise such as a hissing sound generated from a suspension. Such noise may affect ride comfort, and excessive noise can reduce the comfort felt inside a vehicle.

An index or indication (F) corresponds to steering feel, and is an index item indicating the level of response felt by a driver when the vehicle is changing a driving direction, and it is closely related to steering feel and ride comfort. The index (F) indicates whether excessive force is required when the vehicle is changing a driving direction, how well the mid-value is maintained when a steering is not turned, and whether the steering does not move excessively the vehicle when being turned slightly. Predictable and accurate steering feels can give drivers confidence.

An index or indication (G) corresponds to yaw responsiveness and damping, and refers to the level of left and right rotational movement of a vehicle, and the responsiveness and damping indicate how quickly and smoothly the left and right rotational movements of the vehicle are controlled. When yawing is delayed or the response is slow, straight driving performance may deteriorate.

An index or indication (H) corresponds to steer linearity, and is an index item indicating the level of consistency between steering input and a vehicle's response. When the steering is linear, a driver can predict responses of the vehicle in response to steering inputs.

An index or indication (I) corresponds to roll stability, and refers to the stability of a vehicle when the vehicle is cornering. Excessive roll can cause the vehicle to feel unstable.

The indices (A) to (I) in FIG. 2 correspond to various representative factors that determine ride comfort. The values corresponding to each index may be expressed in a spider web diagram as data measured by a specific test or sensor, or as an evaluation score according to a specific standard. Through such a diagram, it may be possible to understand the overall characteristics of ride comfort of a vehicle and the performance related to each factor at a glance and to compare between vehicle types or between vehicles in different tuning states and analyze ride quality. A target ride comfort may change depending on the purpose of the use or driving of a vehicle and the strategy of the manufacturer of the vehicle, and may be expressed in figures through a combination of the indices (A) to (I) in FIG. 2.

In order to tune or optimize the ride comfort of a vehicle, it may be necessary to control the movement and the operation of various actuators, for example, operating elements (e.g., a spring unit, a damper unit, a vibration isolation unit or isolator, an electronic control unit, etc.). As each of those actuators may operate independently or in conjunction with each other, overall ride comfort may be determined.

For example, a flat ride quality means minimizing a vehicle's response to irregularities or impacts on the road so that passengers can experience a stable and comfortable driving. By controlling the stroke of a spring to obtain the characteristics of the opposite satellite of an input signal, shocks or irregularities on the road may be neutralized. Dampers may serve to reduce shock or vibration. By reverse phase, a damper may move in the opposite direction to the movement of a spring, thereby reducing unnecessary vibration or movement. For example, to secure a flat ride, the spring unit may be controlled by 80%, and the damper unit may be controlled by 20%. In other words, it may be possible to control signals in a low frequency (Hz) band. The signals in the low frequency (Hz) band may be an indicator for evaluating the vibration or the response of a vehicle. The low frequency (Hz) band may generally correspond to strong vibrations or impacts, and it may be possible to improve vehicle stability by effectively controlling it.

For a smooth ride, a spring rate and a damping force may be lowered to absorb maximum shock. For example, the spring unit may be controlled by 20%, and the damper unit may be controlled by 80%. In other words, signals in a mid-frequency (Hz) band may be controlled. The signals in the mid-frequency (Hz) band may typically indicate moderate irregularities or impacts on the road. By controlling the signals in the mid-frequency (Hz) band, it may be possible to control a vehicle's response and secure a smooth ride.

For accomplishing the flat ride and the smooth ride, the level of control of the spring unit and the damper unit may be determined based on the indices of ride comfort described above, and the level of control may be changed in various ways as needed.

The spring unit may mainly control the low frequency (Hz) band. In an example in which the spring unit comprises coil springs, only the stroke may be subject to control, and, in an example in which the spring unit comprises air springs, additional variables such as pump capacity and/or speed and compressibility of a fluid may be considered. For the damper unit, the entire frequency (Hz) band may be subject to control and the area to be controlled may expand depending on the characteristics of a valve, and, for example, the damper unit may comprise electronically controlled dampers. For the vibration isolation unit or isolator, the high frequency (Hz) band may be subject to control. The vibration isolation unit or isolator may include a passive vibration isolation unit or isolator and/or an active vibration isolation unit or isolator. The passive vibration isolation unit or isolator may be a device configured to absorb vibration and shock using elastic materials such as rubber or polyurethane. The active vibration isolation unit or isolator may operate in association or combination with an actuator and perform the operation isolating vibration based on control signals corresponding to various types of vibration. Here, the active vibration isolation unit or isolator may be controlled by the properties of variable materials.

When an active suspension is used as a suspension system, it may be possible to actively control the height and the damping force of a vehicle according to control signals. For example, the ECU 140 in FIG. 1 may transmit a control signal to the active suspension to separately control the actuators of the active suspension.

Next, a method of controlling the spring unit, the damper unit, and the vibration isolation unit or isolator based on the frequency resolved by the frequency decoder 120 will be described with reference to FIGS. 3 and 4.

FIG. 3 is a schematic view for schematically showing the profile of a road surface and a suspension system according to an embodiment of the present disclosure. The profile of the road surface may refer to the results of measuring irregularities, defects, and changes in height on the road surface, which are factors that affect ride comfort when a vehicle is driving.

Referring to FIG. 3, a input load received by or applied to the suspension system may be determined by a vehicle body A, a spring unit B, a damper unit C, and a vibration isolation unit or isolator D. In FIG. 3, ms denotes a sprung mass, mu denotes an unsprung mass, Cs denotes a damper damping coefficient, and kt denotes a spring constant of a tire.

The input load measured by the input sensors may be expressed in the time domain as shown in the graph in FIG. 4. The signal of the measured input load in time domain may be converted by the fast Fourier transform (FFT) so that it may be decomposed into frequencies such as f1, f2, f3, f4, and f5.

For example, when the frequency resolved by the frequency decoder 120 falls within a range of 0 Hz to 5 Hz, the spring unit may be controlled by 80%, the damper unit may be controlled by 20%, and the vibration isolation unit or isolator may be controlled by 0%. The frequency in a range of 0 Hz to 5 Hz may mainly control the spring unit. For another example, when the frequency falls within a range of 3 Hz to 25 Hz, the spring unit may be controlled by 10%, the damper unit may be controlled by 60%, and the vibration isolation unit or isolator may be controlled by 30%. The frequency in a range of 3 Hz to 25 Hz may control all of the spring unit, the damper unit, and the vibration isolation unit or isolator so as to secure target ride comfort. For another example, when frequency falls in a range of 20 Hz or more, preferably in a range of 20 Hz to 250 Hz, the spring unit may be controlled by 0%, the damper unit may be controlled by 30%, and the vibration isolation unit or isolator may be controlled by 70%. The frequency in a range of 20 Hz or more may mainly control the damper unit and the vibration isolation unit or isolator. The spring unit, damper unit, and vibration isolation unit or isolator are controlled according to each frequency component to control ride comfort of the vehicle. The spring unit, the damper unit, and the vibration isolation unit or isolator for each frequency may be controlled so as to control the ride comfort of the vehicle. A controlled vehicle may calculate the input load again, decompose the calculated input load into frequencies, and control actuators again based on the decomposed frequencies. This process may be repeated until the calculated ride comfort reaches a target ride comfort. According to an embodiment of the present disclosure, the spring unit, the damper unit, or the vibration isolation unit or isolator may be controlled at the same time depending on frequency, so the duplication of work that occurs while tuning actuators according to the conventional development sequence can be prevented.

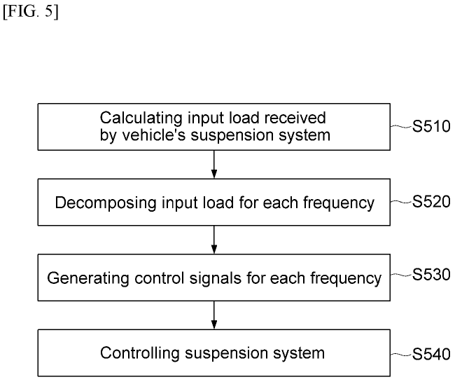

FIG. 5 is a flowchart for showing a method of controlling an actuator to improve riding comfort and steering stability of a vehicle according to an embodiment of the present disclosure.

At step S510, an input load received by or applied to a suspension system of the vehicle (e.g. input loads measured by sensors positioned at various locations in the suspension system) may be calculated. Here, the suspension system may include at least one of a spring unit, a damper unit, and a vibration isolation unit or isolator.

To calculate the input load, one or more sensors may sense the displacement or movement of at least one of the vehicle body, the spring unit, and the damper unit when the vehicle is driving on the road surface having its profile. In addition, in order to calculate the input load, the profile of the road surface may be input by a sensor for inputting information about the front of the vehicle or a high-definition map (HD map). Here, the profile of the road surface may refer to the results of measuring or sensing irregularities, defects, and changes in height on the road surface, which are factors that affect ride comfort when the vehicle is driving. Such a profile may be used as an important indicator in evaluating the wear, the damage, the lifespan, etc. of the road, and, in particular, may be used as important reference factors or materials when designing a vehicle suspension or repairing roads.

At step S520, the input load may be decomposed for each frequency. Here, the frequencies may include at least a first frequency in a first frequency band, a second frequency in a second frequency band, and a third frequency in a third frequency band. For example, the first frequency may be in a range of 0 Hz to 5 Hz, the second frequency may be in a range of 3 Hz to 25 Hz, and the third frequency may be in a range of 20 Hz to 250 Hz.

At step S530, a respective control signal for each frequency may be generated to control at least one of the spring unit, the damper unit, and the vibration isolation unit or isolator included in the suspension system.

At step S540, a respective control signal generated for each frequency may be applied to at least one of the spring unit, the damper unit, and the vibration isolation unit or isolator included in the suspension system in order to control at least one of the spring unit, the damper unit, and the vibration isolation unit or isolator. For example, the spring unit may include a coil spring or an air spring. The coil spring may be controlled such that only the stroke may be controlled by a stroke function in the first frequency, the air spring may be controlled by the pump capacity and the compressibility of a fluid in the first frequency, the damper unit may be controlled according to the characteristics of a valve as a speed function in the second frequency, and the vibration isolation unit or isolator may be controlled by the properties of variable materials in the third frequency.

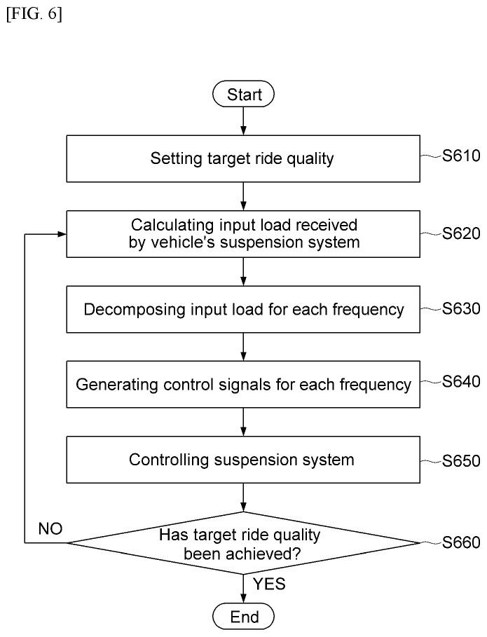

FIG. 6 is a flowchart for showing a method of controlling an actuator to improve riding comfort and steering stability of a vehicle according to another embodiment of the present disclosure.

At step S610, a target ride quality expressed in multiple indices may be set. The target ride comfort may be changed or adjusted depending on the purpose of the use or driving of a vehicle and the strategy of the manufacturer of the vehicle. For example, the target ride comfort may be expressed in figures through a combination of the indices (A) to (I) in FIG. 2.

At step S620, an input load received by or applied to the suspension system of the vehicle (e.g. input loads measured by sensors positioned at various locations in the suspension system) may be calculated. Here, the suspension system may include at least one of a spring unit, a damper unit, and a vibration isolation unit or isolator. To calculate the input load, one or more sensors may sense the displacement or movement of at least one of the vehicle body, the spring unit, and the damper unit when the vehicle passes on the road surface having its profile. In addition, in order to calculate the input load, the profile of the road surface may be input by a sensor for inputting information about the front of the vehicle or a high-definition map (HD map).

At step S630, the input load may be decomposed for each frequency. Here, the frequencies may include at least a first frequency in a first frequency band, a second frequency in a second frequency band, and a third frequency in a third frequency band. For example, the first frequency may be in a range of 0 Hz to 5 Hz, the second frequency may be in a range of 3 Hz to 25 Hz, and the third frequency may be in a range of 20 Hz to 250 Hz.

At step S640, a respective control signal for each frequency may be generated to control at least one of the spring unit, the damper unit, and the vibration isolation unit or isolator included in the suspension system.

At step S650, a respective control signal generated for each frequency may be applied to at least one of the spring unit, the damper unit, and the vibration isolation unit included in the suspension system in order to at least one of the spring unit, the damper unit, and the vibration isolation unit or isolator. For instance, the spring unit may include a coil spring or an air spring. The coil spring may be controlled such that only the stroke may be controlled by a stroke function in the first frequency, the air spring may be controlled by the pump capacity and the compressibility of a fluid in the first frequency, the damper unit may be controlled according to the characteristics of a valve as a speed function in the second frequency, and the vibration isolation unit or isolator may be controlled by the properties of variable materials in the third frequency.

At step S660, it may be determined whether the target ride quality set at step S610 is satisfied in response to the control signal generated at step S650. When the target ride quality set at step S610 is satisfied, the control of actuators may end, and, when the target ride quality set at step S610 is not satisfied, steps S620 to S650 may be repeated until the target ride quality set at step S610 is reached.

The apparatus described above may be formed with hardware components, software components, and/or a combination of hardware and software components. For example, the apparatus and components described in the embodiments of the present disclosure may be formed using one or more general-purpose or special-purpose computers, such as a processor, a controller, an arithmetic logic unit (ALU), a digital signal processor, a microcomputer, a field programmable gate array (FPGA), a programmable logic unit (PLU), a microprocessor, or any other apparatus that can execute instructions and respond. The processing unit may execute an operating system (OS) and one or more software applications running on the OS. In addition, the processing unit may access, store, manipulate, process, and generate data in response to the execution of the software. For ease of understanding, in some cases, it is described that a single processing unit is used, but a person having ordinary skill in the art will understand that such a processing unit may include multiple processing elements and/or multiple types of processing elements. For example, the processing unit may include a plurality of processors or one processor and one controller. In addition, other processing features such as parallel processors may be included.

Although the limited embodiments and drawings have been described as above, a person having ordinary skill in the art can make various modifications and variations to the description above. Even though, for example, the described techniques may be performed in a different order from that in the described method, or the described components such as a system, a structure, an apparatus, and a circuit are combined in a form different from that in the described method or are replaced by other components or equivalents, adequate results can be obtained.

Therefore, other embodiments and equivalents of the claims also fall within the scope of the claims described below.

What is claimed is:

1. A method of controlling an actuator in a vehicle, the method comprising:
calculating an input load received by a suspension system including at least one of a spring unit, a damper unit, and a vibration isolator;
decomposing the calculated input load received by the suspension system for each of frequencies through a frequency decoder;
generating control signals for each of the frequencies based on the input load decomposed for each of frequencies to control at least one of the spring unit, the damper unit, and the vibration isolator included in the suspension system; and
applying the control signals generated for each of the frequencies to at least one of the spring unit, the damper unit, and the vibration isolator included in the suspension system to control at least one of the spring unit, the damper unit, and the vibration isolator.

2. The method of claim 1, wherein the calculating of the input load comprises calculating a profile of a road surface by sensing movement of at least one of a vehicle body, the spring unit, and the damper unit using one or more sensors when the vehicle drives on the road surface.

3. The method of claim 1, wherein the calculating of the input load comprises calculating the input load by receiving a profile of a road surface from one or more sensors for inputting information about a front of the vehicle or a high-definition map (HD map).

4. The method of claim 1, wherein the frequencies include a first frequency in a range of 0 Hz to 5 Hz, a second frequency in a range of 3 Hz to 25 Hz, and a third frequency in a range of 20 Hz to 250 Hz.

5. The method of claim 4, wherein:
the spring unit includes:
a coil spring configured to be controlled such that a stroke is controlled by a stroke function in the first frequency; or
an air spring configured to be controlled by pump capacity and compressibility of a fluid in the first frequency, and
wherein the damper unit is configured to be controlled according to characteristics of a valve as a speed function in the second frequency, and the vibration isolator is configured to be controlled by properties of variable materials in the third frequency.

6. A method of controlling an actuator in a vehicle, the method comprising:
setting a target ride comfort expressed in multiple indices;
calculating an input load received by a′ suspension system including at least one of a spring unit, a damper unit, and a vibration isolator;
decomposing the calculated input load received by the suspension system for each of frequencies through a frequency decoder;
generating control signals for each of the frequencies based on the input load decomposed for each of the frequencies to control at least one of the spring unit, the damper unit, and the vibration isolator included in the suspension system;
applying the control signals generated for each of the frequencies to at least one of the spring unit, the damper unit, and the vibration isolator included in the suspension system to control at least one of the spring unit, the damper unit, and the vibration isolator; and
determining whether the set target ride quality is satisfied in response to the control signals.

7. The method of claim 6, wherein the calculating of the input load comprises calculating a profile of a road surface by sensing movement of at least one of a vehicle body, the spring unit, and the damper unit using one or more sensors when the vehicle drives on the road surface.

8. The method of claim 6, wherein the calculating of the input load comprises calculating the input load by receiving a profile of a road surface from one or more sensors configured to sense in front of the vehicle.

9. The method of claim 6, wherein the calculating of the input load comprises calculating the input load by receiving a profile of a road surface from a high-definition map (HD map).

10. The method of claim 6, wherein the frequencies include a first frequency in a first frequency band, a second frequency in a second frequency band, and a third frequency in a third frequency band.

11. The method of claim 10, wherein:
the spring unit includes:
a coil spring configured to be controlled such that a stroke is controlled by a stroke function in the first frequency; or
an air spring configured to be controlled by pump capacity and compressibility of a fluid in the first frequency, and
wherein the damper unit is configured to be controlled according to characteristics of a valve as a speed function in the second frequency, and the vibration isolator is configured to be controlled by properties of variable materials in the third frequency.

12. The method of claim 10, wherein the first frequency is in a range of 0 Hz to 5 Hz, the second frequency is in a range of 3 Hz to 25 Hz, and the third frequency is in a range of 20 Hz to 250 Hz.

13. The method of claim 6, wherein the multiple indices comprise a combination of two or more of index items of primary ride, impact harshness/hardness, choppy ride, shake vibration, suspension noise, steering feel, yaw response and damping, steer linearity, and roll stability.

14. An apparatus for controlling an actuator in a vehicle, the apparatus comprising:
a suspension system including at least one of a spring unit, a damper unit, and a vibration isolator;
a frequency decoder configured to decompose an input load to the suspension system measured by one or more sensors for each of frequencies by the fast Fourier transform (FFT);
a microcontroller unit (MCU) configured to generate a control value for an actuator configured to control at least one of the spring unit, the damper unit, and the vibration isolator included in the suspension system, based on a target ride comfort expressed in multiple indices; and
an electronic control unit (ECU) configured to receive the control value for the actuator from the MCU to generate a signal to control at least one of the spring unit, the damper unit, and the vibration isolator.

15. The apparatus of claim 14, wherein the MCU is configured to calculate a difference between a resulting value of controlling at least one of the spring unit, the damper unit, and the vibration isolator based on the target ride comfort and a state value indicating a current state of the vehicle, and update the control value for the actuator to satisfy a predetermined target value.

16. The apparatus of claim 14, wherein the input load is calculated by sensing movement of at least one of a vehicle body, the spring unit, and the damper unit using one or more sensors when the vehicle drives on a road surface.

17. The apparatus of claim 14, wherein the input load is calculated by receiving a profile of a road surface from one or more sensors for inputting information about a front of the vehicle or a high-definition map (HD map).

18. The apparatus of claim 15, wherein the frequencies include a first frequency in a first frequency band, a second frequency in a second frequency band, and a third frequency in a third frequency band.

19. The apparatus of claim 18, wherein:
the spring unit includes:
a coil spring configured to be controlled such that a stroke is controlled by a stroke function in the first frequency; or
an air spring configured to be controlled by pump capacity and compressibility of a fluid in the first frequency, and
wherein the damper unit is configured to be controlled according to characteristics of a valve as a speed function in the second frequency, and the vibration isolator is configured to be controlled by properties of variable materials in the third frequency.

20. The apparatus of claim 18, wherein the first frequency is in a range of 0 Hz to 5 Hz, the second frequency is in a range of 3 Hz to 25 Hz, and the third frequency is in a range of 20 Hz to 250 Hz.
